(19) United States
(12) Patent Application Publication
(10) Pub. No.: US 2023/0164375 A1
(43) Pub. Date: May 25, 2023

(54) USING A CANVAS WITH CONTENT STICKERS TO COLLABORATIVELY SHARE AND CONSUME CONTENT BETWEEN USERS

(71) Applicant: Meta Platforms, Inc., Menlo Park, CA (US)

(72) Inventors: Sharon Zeng, Mountain View, CA (US); Sean Leach, Brooklyn, NY (US); Rishi Pankaj Mody, Brooklyn, NY (US)

(21) Appl. No.: 17/535,518

(22) Filed: Nov. 24, 2021

(51) Int. Cl. H04N 21/262; H04N 21/45; H04N 21/431; H04N 21/4725; H04N 21/4788

(52) U.S. Cl. CPC H04N 21/26258; H04N 21/4532; H04N 21/4316; H04N 21/4725; H04N 21/4788

(57) ABSTRACT

Methods, systems, and storage media for sharing content are disclosed. Exemplary implementations may: initiate a conversation through a communication interface of a secure messaging platform; select at least a first content item from a content list; post the first content item to the canvas; play the first content item that was posted to the canvas; select at least a second content item from the content list; post the second content item to the canvas; and queue the second content item to play after the first content item.

### TECHNICAL FIELD

The present disclosure generally relates to sharing content and more particularly to using a canvas with content stickers to collaboratively share and consume content between users.

### BACKGROUND

Conventionally, social media platforms allow users to share content with other users by posting it to their personal social media feeds. Such content may include music (e.g., songs), videos (e.g., music videos), and/or other content. Contacts and/or followers of a given user may be presented with the given user's posts via their own respective social media feeds. Aside from posting content using social media feeds, content may be shared between users via direct messaging features found in social media platforms.

### BRIEF SUMMARY

The subject disclosure provides for systems and methods for sharing content. A user is allowed to collaborate with other users in building queues for content playback and contemporaneously consuming the same content. For example, a group of users may access a canvas such that individual users can add different content to the canvas, the content items can be rearranged by each of the users accessing the canvas, and the content items can be played so that all users accessing the canvas can consume it.

One aspect of the present disclosure relates to a method for sharing content. The method may include initiating a conversation through a communication interface of a secure messaging platform. The communication interface may include a chat room and a canvas. The method may include selecting at least a first content item from a content list. The first content item may include a song or a music video. The method may include posting the first content item to the canvas. The method may include playing the first content item that was posted to the canvas. The method may include selecting at least a second content item from the content list. The method may include posting the second content item to the canvas. The second content item posted after the first content item. The method may include queuing the second content item to play after the first content item.

Another aspect of the present disclosure relates to a system configured for sharing content. The system may include one or more hardware processors configured by machine-readable instructions. The processor(s) may be configured to initiate a conversation through a communication interface of a secure messaging platform. The communication interface may include a chat room and a canvas. The processor(s) may be configured to select at least a first content item from a content list. The first content item may include a song or a music video. The processor(s) may be configured to post the first content item to the canvas. The first content item may be posted as a first sticker on the canvas. The processor(s) may be configured to play the first content item that was posted to the canvas. The processor(s) may be configured to select at least a second content item from the content list. The first content item may be different from the second content item. The processor(s) may be configured to post the second content item to the canvas. The second content item may be posted as a second sticker on the canvas. The second content item posted after the first content item. The processor(s) may be configured to queue the second content item to play after the first content item.

Yet another aspect of the present disclosure relates to a non-transient computer-readable storage medium having instructions embodied thereon, the instructions being executable by one or more processors to perform a method for sharing content. The method may include initiating a conversation through a communication interface of a secure messaging platform. The communication interface may include a chat room and a canvas. The chat room may include a virtual space in which users can exchange message-based communications. The canvas may include a virtual space in which users can collaboratively share, curate, and/or consume the same content items. The method may include selecting at least a first content item from a content list. The first content item may include a song or a music video. The content list may be arranged based on one or more of popularity of individual content items in the content list, user preferences, personal playlists of a user, playlists of contacts of a user, and/or preferences of contacts of a user. The method may include posting the first content item to the canvas. The first content item may be posted as a first sticker on the canvas. The method may include playing the first content item that was posted to the canvas. The method may include selecting at least a second content item from the content list. The first content item may be different from the second content item. The method may include posting the second content item to the canvas. The second content item posted after the first content item. The second content item may be posted as a second sticker on the canvas. The second content item may be depicted on the canvas as being positioned at least partially below or behind the first content item. The method may include queuing the second content item to play after the first content item. Playback of the first content item and the second content item may be configured to be controllable by any user accessing the canvas.

Still another aspect of the present disclosure relates to a system configured for sharing content. The system may include means for initiating a conversation through a communication interface of a secure messaging platform. The communication interface may include a chat room and a canvas. The system may include means for selecting at least a first content item from a content list. The first content item may include a song or a music video. The system may include means for posting the first content item to the canvas. The system may include means for playing the first content item that was posted to the canvas. The system may include means for selecting at least a second content item from the content list. The system may include means for posting the second content item to the canvas. The second content item posted after the first content item. The system may include means for queuing the second content item to play after the first content item.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example view of an application, configured for using content stickers to share content between users, through which content may be selected for sharing, according to certain aspects of the disclosure.

FIG. 2 illustrates an example view of the application through which selected content may be represented, according to certain aspects of the disclosure.

FIG. 3 illustrates an example view of the application through which a queue of selected content may be represented, according to certain aspects of the disclosure.

FIG. 4 illustrates an example view of the application through which users consuming the selected content can provide reactions, according to certain aspects of the disclosure.

FIG. 5 illustrates a system configured for sharing content, in accordance with one or more implementations.

FIG. 6 illustrates an example flow diagram for sharing content, according to certain aspects of the disclosure.

FIG. 7 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

In existing social media and messaging platforms, content sharing and curation typically originates with a single user. That is, users individually post content, individually broadcast their posts to other users and, ultimately, individually consume posted content. As such, users cannot collaboratively share, curate, and/or consume content.

The subject disclosure provides for systems and methods for sharing content. A user is allowed to collaborate with other users in building queues for content playback and contemporaneously consuming the same content. For example, a group of users may access a canvas such that individual users can add different content to the canvas, the content items can be rearranged by each of the users accessing the canvas, and the content items can be played so that all users accessing the canvas can consume it.

Implementations described herein address the aforementioned shortcomings and other shortcomings by providing a “collaborative canvas” space through which multiple people in the same space can share, curate, and/or consume the same content. These capabilities may be provided via a client of a social media platform running on a user device to facilitate users in co-sharing, co-curating, co-consuming (e.g., co-listening and/or or co-viewing).

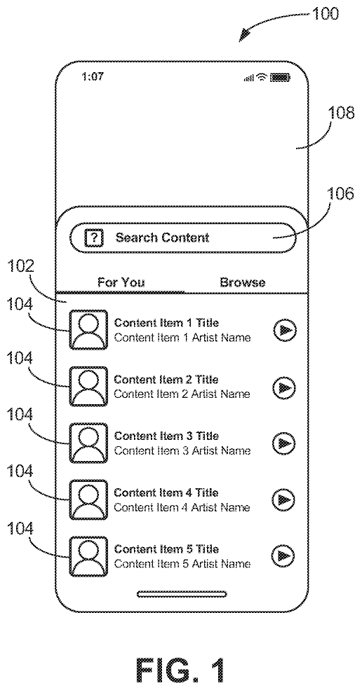

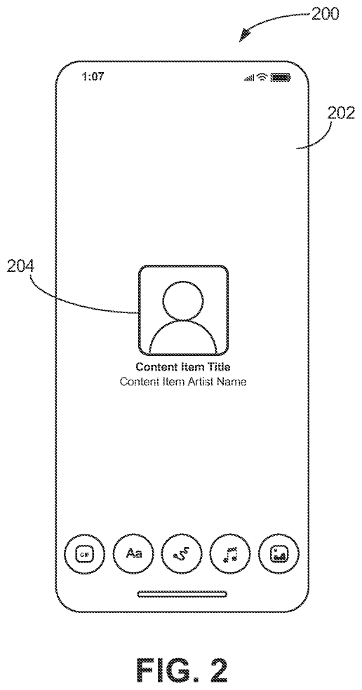

FIG. 1 illustrates an example view 100 of an application, configured for using content stickers to share content between users, through which content may be selected for sharing, according to certain aspects of the disclosure. The application may include a client running on a user device. The client may be of a secure messaging platform, a social media platform, and/or other platforms. The view 100 may include a content list 102. The content list 102 may include a plurality of content items 104. The content items 104 may be represented on the content list 102 by one or more of icons, thumbnails, textual description, and/or other visual representations. The content items 104 may be searchable through search field 106. The content list 102 may be arranged specifically for the user. The user may select one or more of the content items 104 from the content list 102 by one or more of clicking on individual content items, tapping on individual content items, and/or dragging and dropping individual content items from the content list 102 to canvas 108 (described further in connection with FIGS. 2-4).

FIG. 2 illustrates an example view 200 of the application through which selected content may be represented, according to certain aspects of the disclosure. The view 200 may include a canvas 202. On the canvas 202, a sticker 204 is displayed. The sticker 204 may visually represent a content item from a content list (e.g., content items 104 and content list 102 in FIG. 1). According to some implementations, all users accessing the canvas 202 may add and remove content stickers from canvas 202. The content item corresponding to sticker 204 may be played by any user accessing the canvas 202. When the content item is played, all users accessing the canvas 202 may simultaneously consume (e.g., listen to or view) playback of the content item.

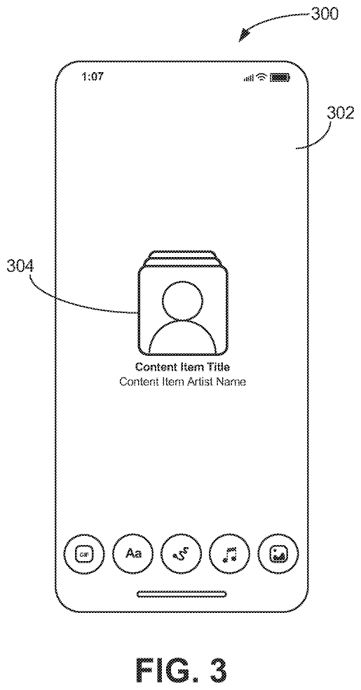

FIG. 3 illustrates an example view 300 of the application through which a queue of selected content may be represented, according to certain aspects of the disclosure. The view 300 may include a canvas 302. On the canvas 302, a playback queue 204 may be displayed as a stack of stickers (e.g., sticker 204 in FIG. 2). Stickers in the playback queue 204 may be arranged such that the sticker corresponding to the content item added most recently to canvas 302 is positioned behind all other stickers on the canvas 302. In some implementations, only the content item associated with the top sticker may be played. Stickers in the playback queue 204 may be rearranged by one or more users accessing the canvas 302.

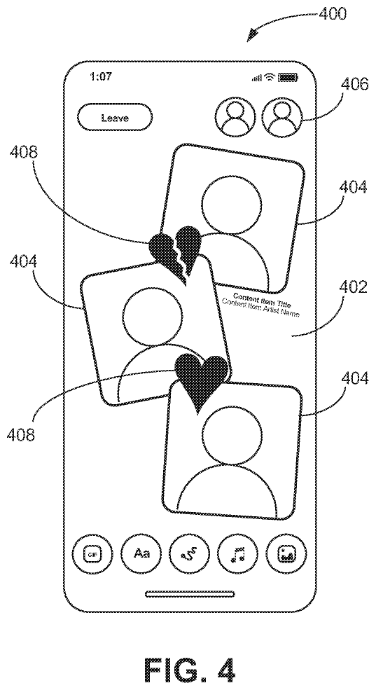

FIG. 4 illustrates an example view 400 of the application through which users consuming the selected content can provide reactions, according to certain aspects of the disclosure. The view 400 may include a canvas 402. On the canvas 402, several stickers 404 may be displayed. The canvas 402 may be accessed by users represented by user icons 406. Individual users may add reactions 408 to the canvas 402 and/or to individual stickers 404. The reactions 408 may include one or more of emojis, symbols, text, and/or other visual indicators. The reactions 408 may convey whether individual users access the canvas 402 like or dislike content items corresponding to the different stickers 404. The reactions 408 may be added, changed, and/or removed by individual users accessing the canvas 402. In some implementations, a given reaction 408 may only be changed and/or removed by the user that added the given reaction 408 to the canvas 402. In some implementations, a given sticker 404 may be removed from the canvas 402 responsive to it receiving a threshold number of negative reactions 408.

The disclosed system(s) address a problem in traditional content sharing techniques tied to computer technology, namely, the technical problem of collaboratively sharing and consuming content. The disclosed system solves this technical problem by providing a solution also rooted in computer technology, namely, by providing for using a canvas with content stickers to collaboratively share and consume content between users. The disclosed subject technology further provides improvements to the functioning of the computer itself because it improves processing and efficiency in content sharing.

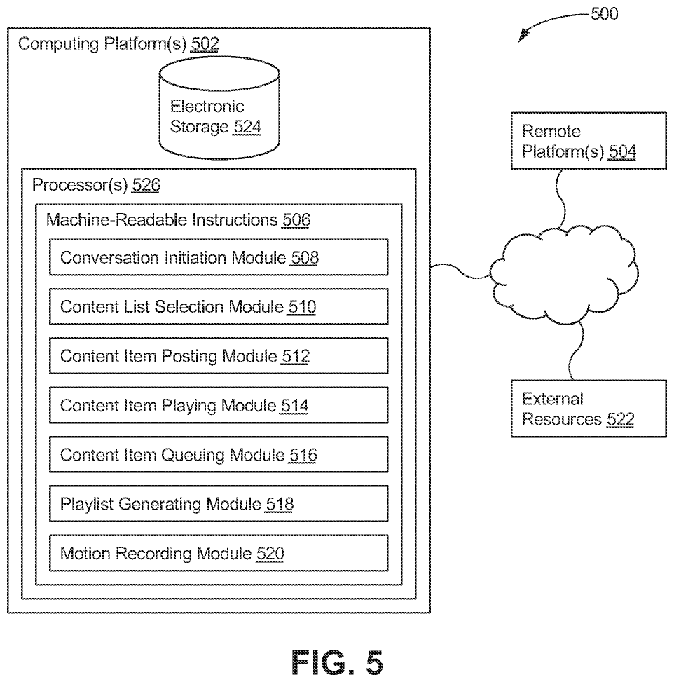

FIG. 5 illustrates a system 500 configured for sharing content, according to certain aspects of the disclosure. In some implementations, system 500 may include one or more computing platforms 502. Computing platform(s) 502 may be configured to communicate with one or more remote platforms 504 according to a client/server architecture, a peer-to-peer architecture, and/or other architectures. Remote platform(s) 504 may be configured to communicate with other remote platforms via computing platform(s) 502 and/or according to a client/server architecture, a peer-to-peer architecture, and/or other architectures. Users may access system 500 via remote platform(s) 504.

Computing platform(s) 502 may be configured by machine-readable instructions 506. Machine-readable instructions 506 may include one or more instruction modules. The instruction modules may include computer program modules. The instruction modules may include one or more of conversation initiation module 508, content list selection module 510, content item posting module 512, content item playing module 514, content item queuing module 516, playlist generating module 518, motion recording module 520, and/or other instruction modules.

Conversation initiation module 508 may be configured to initiate a conversation through a communication interface of a secure messaging platform. The secure messaging platform may be configured to facilitate end-to-end encryption for message-based communications between users. The secure messaging platform may be a messaging feature of a social media platform. The communication interface may include a chat interface and/or other interfaces. The communication interface may include a chat room and a canvas. The canvas may be included in a separate interface from the chat room.

The chat room may include a virtual space in which users can exchange message-based communications. By way of non-limiting example, the message-based communications may include one or more of text messages, audio messages, and/or video messages.

The canvas may include a virtual space in which users can collaboratively share, curate, and/or consume the same content items. In some implementations, individual users accessing the canvas can add, remove, and/or rearrange content items displayed via the canvas. In some implementations, all users accessing the canvas can add, remove, and/or rearrange content items displayed via the canvas. In some implementations, an admin user accessing the canvas can add, remove, and/or rearrange content items displayed via the canvas. In some implementations, some users accessing the canvas cannot add, remove, and/or rearrange content items displayed via the canvas. The canvas may be configured to facilitate building a queue of content items for sequential playback.

Users may add reactions to the canvas. In some implementations, users may add reactions to the posted content items. The reactions may include emojis and/or other visual indications. Adding the reactions to the canvas may be responsive to tapping and/or clicking on one or more of individual content items, groups of content items, and/or other areas on the canvas. In some implementations, individual reactions may be associated with individual content items.

Content list selection module 510 may be configured to select at least a first content item from a content list. The content list may be accessible via the canvas. By way of non-limiting example, a given content item of the plurality of content items may include one or more of a song, a music video, a voice recording, an image, an animated image, and/or a video feed. By way of non-limiting example, the content list may be arranged based on one or more of popularity of individual content items in the content list, user preferences, users personal playlists, playlists of contacts of a user, and/or preferences of contacts of a user. The content list may include a plurality of content items. Selecting at least the first content item may be responsive to a click or tap on the first content item as displayed in the content list. Selecting at least the first content item may be responsive to dragging and dropping the first content item from the content list to the canvas.

Content list selection module 510 may be configured to select at least a second content item from the content list. In some implementations, the first content item may be different from the second content item.

Content item posting module 512 may be configured to post the first content item to the canvas. Posting the first content item to the canvas may include adding the first content item to the canvas. In some implementations, the first content item may be posted as a sticker. The sticker may include a visual representation of the first content item. The visual representation may include a static image and/or an animated image associated with the first content item. The sticker may be an object on the canvas. Different stickers may correspond to different content items. The sticker may be rearranged among other stickers on the canvas. The sticker may be dragged and dropped at different positions on the canvas. The sticker may be removed from the canvas responsive to swiping the sticker off the canvas. The sticker may be manipulated by some or all users accessing the canvas.

Content item posting module 512 may be configured to post the second content item to the canvas. Posting the second content item to the canvas may include adding the second content item to the canvas. The second content item posted after the first content item. In some implementations, the second content item may be depicted as being positioned at least partially below or behind the first content item. In some implementations, by way of non-limiting example, a first user may select and post the first content item, and a second user may select and post the second content item. The first user may be different from the second user.

Content item playing module 514 may be configured to play the first content item that was posted to the canvas. Playing the first content item may be responsive to a click or tap on the first content item as displayed via the canvas. In some implementations, playing the first content item may include indicating a portion of the first content item to play. Playback of the first content item and the second content item may be configured to be controllable by any user accessing the canvas. By way of non-limiting example, controlling the playback of the first content item and the second content item may include one or more of starting, stopping, and/or skipping playback.

Content item queuing module 516 may be configured to queue the second content item to play after the first content item. Content items may be included in a playback queue in the order they were added to the canvas. For example, the most recent content item added to the canvas may be positioned last in the playback queue. Users accessing the canvas may reorder the playback queue. Users accessing the canvas may add and remove content items from the playback queue by adding and removing content items from the canvas.

Playlist generating module 518 may be configured to generate a playlist based on the selected content items. The playlist may be based on one or more of content items in the content list, content items on the canvas, and/or content items in a playback queue. The playlist may be shareable to users accessing the canvas. The playlist may be shareable to users not accessing the canvas.

Motion recording module 520 may be configured to record a motion of a sticker. The motion of the sticker may include motion of the sticker on the canvas. The motion of the sticker may be caused by user interactions with the sticker and/or the canvas. The interactions may include one or more of tapping, clicking, swiping, dragging-and-dropping, and/or other user interactions. Motion of the sticker may affect its position relative to other stickers on the canvas. The stickers' relative positions may be used to determine a playback queue.

In some implementations, computing platform(s) 502, remote platform(s) 504, and/or external resources 522 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 502, remote platform(s) 504, and/or external resources 522 may be operatively linked via some other communication media.

A given remote platform 504 may include one or more processors configured to execute computer program modules. The computer program modules may be configured to enable an expert or user associated with the given remote platform 504 to interface with system 500 and/or external resources 522, and/or provide other functionality attributed herein to remote platform(s) 504. By way of non-limiting example, a given remote platform 504 and/or a given computing platform 502 may include one or more of a server, a desktop computer, a laptop computer, a handheld computer, a tablet computing platform, a NetBook, a Smartphone, a gaming console, and/or other computing platforms.

External resources 522 may include sources of information outside of system 500, external entities participating with system 500, and/or other resources. In some implementations, some or all of the functionality attributed herein to external resources 522 may be provided by resources included in system 500.

Computing platform(s) 502 may include electronic storage 524, one or more processors 526, and/or other components. Computing platform(s) 502 may include communication lines, or ports to enable the exchange of information with a network and/or other computing platforms. Illustration of computing platform(s) 502 in FIG. 5 is not intended to be limiting. Computing platform(s) 502 may include a plurality of hardware, software, and/or firmware components operating together to provide the functionality attributed herein to computing platform(s) 502. For example, computing platform(s) 502 may be implemented by a cloud of computing platforms operating together as computing platform(s) 502.

Electronic storage 524 may comprise non-transitory storage media that electronically stores information. The electronic storage media of electronic storage 524 may include one or both of system storage that is provided integrally (i.e., substantially non-removable) with computing platform(s) 502 and/or removable storage that is removably connectable to computing platform(s) 502 via, for example, a port (e.g., a USB port, a firewire port, etc.) or a drive (e.g., a disk drive, etc.). Electronic storage 524 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 524 may include one or more virtual storage resources (e.g., cloud storage, a virtual private network, and/or other virtual storage resources). Electronic storage 524 may store software algorithms, information determined by processor(s) 526, information received from computing platform(s) 502, information received from remote platform(s) 504, and/or other information that enables computing platform(s) 502 to function as described herein.

Processor(s) 526 may be configured to provide information processing capabilities in computing platform(s) 502. As such, processor(s) 526 may include one or more of a digital processor, an analog processor, a digital circuit designed to process information, an analog circuit designed to process information, a state machine, and/or other mechanisms for electronically processing information. Although processor(s) 526 is shown in FIG. 5 as a single entity, this is for illustrative purposes only. In some implementations, processor(s) 526 may include a plurality of processing units. These processing units may be physically located within the same device, or processor(s) 526 may represent processing functionality of a plurality of devices operating in coordination. Processor(s) 526 may be configured to execute modules 508, 510, 512, 514, 516, 518, and/or 520, and/or other modules. Processor(s) 526 may be configured to execute modules 508, 510, 512, 514, 516, 518, and/or 520, and/or other modules by software; hardware; firmware; some combination of software, hardware, and/or firmware; and/or other mechanisms for configuring processing capabilities on processor(s) 526. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 508, 510, 512, 514, 516, 518, and/or 520 are illustrated in FIG. 5 as being implemented within a single processing unit, in implementations in which processor(s) 526 includes multiple processing units, one or more of modules 508, 510, 512, 514, 516, 518, and/or 520 may be implemented remotely from the other modules. The description of the functionality provided by the different modules 508, 510, 512, 514, 516, 518, and/or 520 described below is for illustrative purposes, and is not intended to be limiting, as any of modules 508, 510, 512, 514, 516, 518, and/or 520 may provide more or less functionality than is described. For example, one or more of modules 508, 510, 512, 514, 516, 518, and/or 520 may be eliminated, and some or all of its functionality may be provided by other ones of modules 508, 510, 512, 514, 516, 518, and/or 520. As another example, processor(s) 526 may be configured to execute one or more additional modules that may perform some or all of the functionality attributed below to one of modules 508, 510, 512, 514, 516, 518, and/or 520.

In particular embodiments, one or more objects (e.g., content or other types of objects) of a computing system may be associated with one or more privacy settings. The one or more objects may be stored on or otherwise associated with any suitable computing system or application, such as, for example, a social-networking system, a client system, a third-party system, a social-networking application, a messaging application, a photo-sharing application, or any other suitable computing system or application. Although the examples discussed herein are in the context of an online social network, these privacy settings may be applied to any other suitable computing system. Privacy settings (or “access settings”) for an object may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example and not by way of limitation, a user of the online social network may specify privacy settings for a user-profile page that identify a set of users that may access work-experience information on the user-profile page, thus excluding other users from accessing that information.

In particular embodiments, privacy settings for an object may specify a “blocked list” of users or other entities that should not be allowed to access certain information associated with the object. In particular embodiments, the blocked list may include third-party entities. The blocked list may specify one or more users or entities for which an object is not visible. As an example and not by way of limitation, a user may specify a set of users who may not access photo albums associated with the user, thus excluding those users from accessing the photo albums (while also possibly allowing certain users not within the specified set of users to access the photo albums). In particular embodiments, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example and not by way of limitation, a particular concept node corresponding to a particular photo may have a privacy setting specifying that the photo may be accessed only by users tagged in the photo and friends of the users tagged in the photo. In particular embodiments, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular embodiments, privacy settings may be based on one or more nodes or edges of a social graph. A privacy setting may be specified for one or more edges or edge-types of the social graph, or with respect to one or more nodes, or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example and not by way of limitation, a first user may share an object to the social-networking system. The object may be associated with a concept node connected to a user node of the first user by an edge. The first user may specify privacy settings that apply to a particular edge connecting to the concept node of the object, or may specify privacy settings that apply to all edges connecting to the concept node. As another example and not by way of limitation, the first user may share a set of objects of a particular object-type (e.g., a set of images). The first user may specify privacy settings with respect to all objects associated with the first user of that particular object-type as having a particular privacy setting (e.g., specifying that all images posted by the first user are visible only to friends of the first user and/or users tagged in the images).

In particular embodiments, the social-networking system may present a “privacy wizard” (e.g., within a webpage, a module, one or more dialog boxes, or any other suitable interface) to the first user to assist the first user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular embodiments, the social-networking system may offer a “dashboard” functionality to the first user that may display, to the first user, current privacy settings of the first user. The dashboard functionality may be displayed to the first user at any appropriate time (e.g., following an input from the first user summoning the dashboard functionality, following the occurrence of a particular event or trigger action). The dashboard functionality may allow the first user to modify one or more of the first user's current privacy settings at any time, in any suitable manner (e.g., redirecting the first user to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular embodiments, one or more servers may be authorization/privacy servers for enforcing privacy settings. In response to a request from a user (or other entity) for a particular object stored in a data store, the social-networking system may send a request to the data store for the object. The request may identify the user associated with the request and the object may be sent only to the user (or a client system of the user) if the authorization server determines that the user is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular embodiments, an object may represent content that is visible to a user through a newsfeed of the user. As an example and not by way of limitation, one or more objects may be visible to a user's “Trending” page. In particular embodiments, an object may correspond to a particular user. The object may be content associated with the particular user, or may be the particular user's account or information stored on the social-networking system, or other computing system. As an example and not by way of limitation, a first user may view one or more second users of an online social network through a “People You May Know” function of the online social network, or by viewing a list of friends of the first user. As an example and not by way of limitation, a first user may specify that they do not wish to see objects associated with a particular second user in their newsfeed or friends list. If the privacy settings for the object do not allow it to be surfaced to, discovered by, or visible to the user, the object may be excluded from the search results. Although this disclosure describes enforcing privacy settings in a particular manner, this disclosure contemplates enforcing privacy settings in any suitable manner.

In particular embodiments, different objects of the same type associated with a user may have different privacy settings. Different types of objects associated with a user may have different types of privacy settings. As an example and not by way of limitation, a first user may specify that the first user's status updates are public, but any images shared by the first user are visible only to the first user's friends on the online social network. As another example and not by way of limitation, a user may specify different privacy settings for different types of entities, such as individual users, friends-of-friends, followers, user groups, or corporate entities. As another example and not by way of limitation, a first user may specify a group of users that may view videos posted by the first user, while keeping the videos from being visible to the first user's employer. In particular embodiments, different privacy settings may be provided for different user groups or user demographics. As an example and not by way of limitation, a first user may specify that other users who attend the same university as the first user may view the first user's pictures, but that other users who are family members of the first user may not view those same pictures.

In particular embodiments, the social-networking system may provide one or more default privacy settings for each object of a particular object-type. A privacy setting for an object that is set to a default may be changed by a user associated with that object. As an example and not by way of limitation, all images posted by a first user may have a default privacy setting of being visible only to friends of the first user and, for a particular image, the first user may change the privacy setting for the image to be visible to friends and friends-of-friends.

In particular embodiments, privacy settings may allow a first user to specify (e.g., by opting out, by not opting in) whether the social-networking system may receive, collect, log, or store particular objects or information associated with the user for any purpose. In particular embodiments, privacy settings may allow the first user to specify whether particular applications or processes may access, store, or use particular objects or information associated with the user. The privacy settings may allow the first user to opt in or opt out of having objects or information accessed, stored, or used by specific applications or processes. The social-networking system may access such information in order to provide a particular function or service to the first user, without the social-networking system having access to that information for any other purposes. Before accessing, storing, or using such objects or information, the social-networking system may prompt the user to provide privacy settings specifying which applications or processes, if any, may access, store, or use the object or information prior to allowing any such action. As an example and not by way of limitation, a first user may transmit a message to a second user via an application related to the online social network (e.g., a messaging app), and may specify privacy settings that such messages should not be stored by the social-networking system.

In particular embodiments, a user may specify whether particular types of objects or information associated with the first user may be accessed, stored, or used by the social-networking system. As an example and not by way of limitation, the first user may specify that images sent by the first user through the social-networking system may not be stored by the social-networking system. As another example and not by way of limitation, a first user may specify that messages sent from the first user to a particular second user may not be stored by the social-networking system. As yet another example and not by way of limitation, a first user may specify that all objects sent via a particular application may be saved by the social-networking system.

In particular embodiments, privacy settings may allow a first user to specify whether particular objects or information associated with the first user may be accessed from particular client systems or third-party systems. The privacy settings may allow the first user to opt in or opt out of having objects or information accessed from a particular device (e.g., the phone book on a user's smart phone), from a particular application (e.g., a messaging app), or from a particular system (e.g., an email server). The social-networking system may provide default privacy settings with respect to each device, system, or application, and/or the first user may be prompted to specify a particular privacy setting for each context. As an example and not by way of limitation, the first user may utilize a location-services feature of the social-networking system to provide recommendations for restaurants or other places in proximity to the user. The first user's default privacy settings may specify that the social-networking system may use location information provided from a client device of the first user to provide the location-based services, but that the social-networking system may not store the location information of the first user or provide it to any third-party system. The first user may then update the privacy settings to allow location information to be used by a third-party image-sharing application in order to geo-tag photos.

In particular embodiments, privacy settings may allow a user to specify one or more geographic locations from which objects can be accessed. Access or denial of access to the objects may depend on the geographic location of a user who is attempting to access the objects. As an example and not by way of limitation, a user may share an object and specify that only users in the same city may access or view the object. As another example and not by way of limitation, a first user may share an object and specify that the object is visible to second users only while the first user is in a particular location. If the first user leaves the particular location, the object may no longer be visible to the second users. As another example and not by way of limitation, a first user may specify that an object is visible only to second users within a threshold distance from the first user. If the first user subsequently changes location, the original second users with access to the object may lose access, while a new group of second users may gain access as they come within the threshold distance of the first user.

In particular embodiments, changes to privacy settings may take effect retroactively, affecting the visibility of objects and content shared prior to the change. As an example and not by way of limitation, a first user may share a first image and specify that the first image is to be public to all other users. At a later time, the first user may specify that any images shared by the first user should be made visible only to a first user group. The social-networking system may determine that this privacy setting also applies to the first image and make the first image visible only to the first user group. In particular embodiments, the change in privacy settings may take effect only going forward. Continuing the example above, if the first user changes privacy settings and then shares a second image, the second image may be visible only to the first user group, but the first image may remain visible to all users. In particular embodiments, in response to a user action to change a privacy setting, the social-networking system may further prompt the user to indicate whether the user wants to apply the changes to the privacy setting retroactively. In particular embodiments, a user change to privacy settings may be a one-off change specific to one object. In particular embodiments, a user change to privacy may be a global change for all objects associated with the user.

In particular embodiments, the social-networking system may determine that a first user may want to change one or more privacy settings in response to a trigger action associated with the first user. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, the social-networking system may prompt the first user to change the privacy settings regarding the visibility of objects associated with the first user. The prompt may redirect the first user to a workflow process for editing privacy settings with respect to one or more entities associated with the trigger action. The privacy settings associated with the first user may be changed only in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example and not by way of limitation, a user's default privacy settings may indicate that a person's relationship status is visible to all users (i.e., “public”). However, if the user changes his or her relationship status, the social-networking system may determine that such action may be sensitive and may prompt the user to confirm that his or her relationship status should remain public before proceeding. As another example and not by way of limitation, a user's privacy settings may specify that the user's posts are visible only to friends of the user. However, if the user changes the privacy setting for his or her posts to being public, the social-networking system may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular embodiments, a user may need to provide verification of a privacy setting on a periodic basis. A prompt or reminder may be periodically sent to the user based either on time elapsed or a number of user actions. As an example and not by way of limitation, the social-networking system may send a reminder to the user to confirm his or her privacy settings every six months or after every ten photo posts. In particular embodiments, privacy settings may also allow users to control access to the objects or information on a per-request basis. As an example and not by way of limitation, the social-networking system may notify the user whenever a third-party system attempts to access information associated with the user, and require the user to provide verification that access should be allowed before proceeding.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

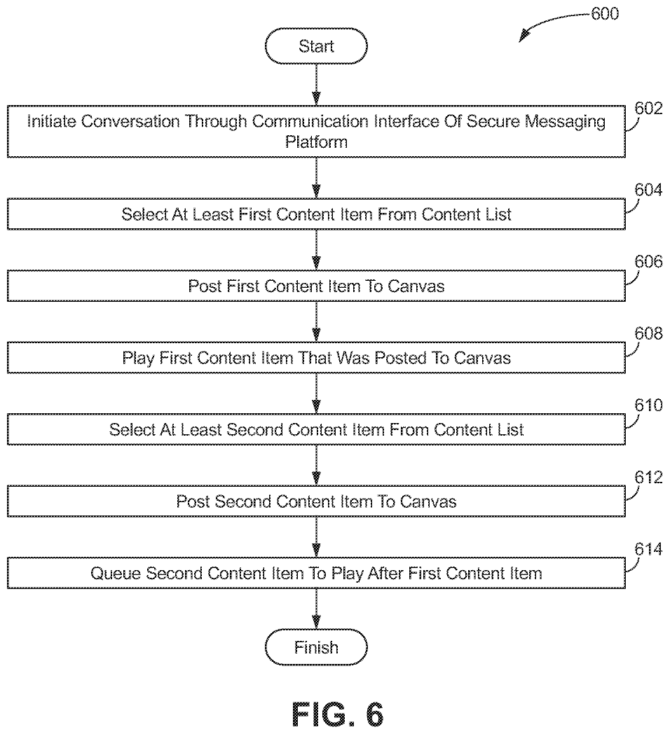

FIG. 6 illustrates an example flow diagram (e.g., process 600) for sharing content, according to certain aspects of the disclosure. For explanatory purposes, the example process 600 is described herein with reference to FIGS. 1-5. Further for explanatory purposes, the steps of the example process 600 are described herein as occurring in serial, or linearly. However, multiple instances of the example process 600 may occur in parallel. For purposes of explanation of the subject technology, the process 600 will be discussed in reference to FIGS. 1-5.

At a step 602, the process 600 may include initiating a conversation through a communication interface of a secure messaging platform, the communication interface comprising a chat room and a canvas. At a step 604, the process 600 may include selecting at least a first content item from a content list, the first content item including a song or a music video. At a step 606, the process 600 may include posting the first content item to the canvas. At a step 608, the process 600 may include playing the first content item that was posted to the canvas. At a step 610, the process 600 may include selecting at least a second content item from the content list. At a step 612, the process 600 may include posting the second content item to the canvas, the second content item posted after the first content item. At a step 614, the process 600 may include queuing the second content item to play after the first content item.

For example, as described above in relation to FIGS. 1-5, at a step 602, the process 600 may include initiating a conversation through a communication interface of a secure messaging platform, the communication interface comprising a chat room and a canvas, through conversation initiation module 508. At a step 604, the process 600 may include selecting at least a first content item from a content list, through content list selection module 510. The first content item may include a song, a music video, and/or other content. At a step 606, the process 600 may include posting the first content item to the canvas, through content item posting module 512. At a step 608, the process 600 may include playing the first content item that was posted to the canvas, through content item playing module 514. At a step 610, the process 600 may include selecting at least a second content item from the content list, through content list selection module 510. At a step 612, the process 600 may include posting the second content item to the canvas, through content item posting module 512. The second content item may be posted after the first content item. At a step 614, the process 600 may include queuing the second content item to play after the first content item, through content item queuing module 516.

According to an aspect, the canvas is included in a separate interface from the chat room.

According to an aspect, the first content item is posted as a sticker.

According to an aspect, a first user selects and posts the first content item, and a second user selects and posts the second content item.

According to an aspect, the first user is different from the second user.

According to an aspect, the first content item is different from the second content item.

According to an aspect, the content list is arranged based on one or more of popularity of individual content items in the content list, user preferences, user's personal playlists, playlists of contacts of a user, and/or preferences of contacts of a user.

According to an aspect, playback of the first content item and the second content item is configured to be controllable by any user accessing the canvas.

According to an aspect, the process 600 further includes generating a playlist based on the selected content items.

According to an aspect, the process 600 further includes recording a motion of a sticker.

According to an aspect, users may add reactions to the canvas.

According to an aspect, users may add reactions to the posted content items.

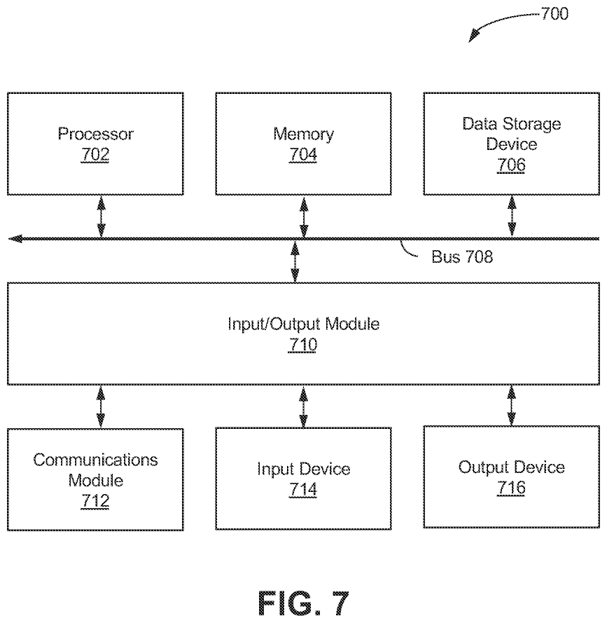

FIG. 7 is a block diagram illustrating an exemplary computer system 700 with which aspects of the subject technology can be implemented. In certain aspects, the computer system 700 may be implemented using hardware or a combination of software and hardware, either in a dedicated server, integrated into another entity, or distributed across multiple entities.

Computer system 700 (e.g., server and/or client) includes a bus 708 or other communication mechanism for communicating information, and a processor 702 coupled with bus 708 for processing information. By way of example, the computer system 700 may be implemented with one or more processors 702. Processor 702 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 700 can include, in addition to hardware, code that creates an execution environment for the computer program in question, e.g., code that constitutes processor firmware, a protocol stack, a database management system, an operating system, or a combination of one or more of them stored in an included memory 704, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 708 for storing information and instructions to be executed by processor 702. The processor 702 and the memory 704 can be supplemented by, or incorporated in, special purpose logic circuitry.

The instructions may be stored in the memory 704 and implemented in one or more computer program products, i.e., one or more modules of computer program instructions encoded on a computer-readable medium for execution by, or to control the operation of, the computer system 700, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 704 may also be used for storing temporary variable or other intermediate information during execution of instructions to be executed by processor 702.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 700 further includes a data storage device 706 such as a magnetic disk or optical disk, coupled to bus 708 for storing information and instructions. Computer system 700 may be coupled via input/output module 710 to various devices. The input/output module 710 can be any input/output module. Exemplary input/output modules 710 include data ports such as USB ports. The input/output module 710 is configured to connect to a communications module 712. Exemplary communications modules 712 include networking interface cards, such as Ethernet cards and modems. In certain aspects, the input/output module 710 is configured to connect to a plurality of devices, such as an input device 714 and/or an output device 716. Exemplary input devices 714 include a keyboard and a pointing device, e.g., a mouse or a trackball, by which a user can provide input to the computer system 700. Other kinds of input devices 714 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 716 include display devices such as an LCD (liquid crystal display) monitor, for displaying information to the user.

According to one aspect of the present disclosure, the above-described gaming systems can be implemented using a computer system 700 in response to processor 702 executing one or more sequences of one or more instructions contained in memory 704. Such instructions may be read into memory 704 from another machine-readable medium, such as data storage device 706. Execution of the sequences of instructions contained in the main memory 704 causes processor 702 to perform the process steps described herein. One or more processors in a multi-processing arrangement may also be employed to execute the sequences of instructions contained in memory 704. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 700 can include clients and servers. A client and server are generally remote from each other and typically interact through a communication network. The relationship of client and server arises by virtue of computer programs running on the respective computers and having a client-server relationship to each other. Computer system 700 can be, for example, and without limitation, a desktop computer, laptop computer, or tablet computer. Computer system 700 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 702 for execution. Such a medium may take many forms, including, but not limited to, non-volatile media, volatile media, and transmission media. Non-volatile media include, for example, optical or magnetic disks, such as data storage device 706. Volatile media include dynamic memory, such as memory 704. Transmission media include coaxial cables, copper wire, and fiber optics, including the wires that comprise bus 708. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 700 reads game data and provides a game, information may be read from the game data and stored in a memory device, such as the memory 704. Additionally, data from the memory 704 servers accessed via a network the bus 708, or the data storage 706 may be read and loaded into the memory 704. Although data is described as being found in the memory 704, it will be understood that data does not have to be stored in the memory 704 and may be stored in other memory accessible to the processor 702 or distributed among several media, such as the data storage 706.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for sharing content, the method comprising:
initiating a conversation through a communication interface of a secure messaging platform, the communication interface comprising a chat room and a canvas;
selecting at least a first content item from a content list, the first content item including a song or a music video;
posting the first content item to the canvas;
playing the first content item that was posted to the canvas;
selecting at least a second content item from the content list;
posting the second content item to the canvas, the second content item posted after the first content item; and
queuing the second content item to play after the first content item.

2. The method of claim 1, wherein the canvas is included in a separate interface from the chat room.

3. The method of claim 1, wherein the first content item is posted as a sticker.

4. The method of claim 1, wherein a first user selects and posts the first content item, and a second user selects and posts the second content item.

5. The method of claim 4, wherein the first user is different from the second user.

6. The method of claim 1, wherein the first content item is different from the second content item.

7. The method of claim 1, wherein the content list is arranged based on one or more of popularity of individual content items in the content list, user preferences, users personal playlists, playlists of contacts of a user, and/or preferences of contacts of a user.

8. The method of claim 1, wherein playback of the first content item and the second content item is configured to be controllable by any user accessing the canvas.

9. The method of claim 1, further comprising:
generating a playlist based on the selected content items.

10. The method of claim 3, further comprising:
recording a motion of a sticker.

11. A system configured for sharing content, the system comprising:
one or more hardware processors configured by machine-readable instructions to:
initiate a conversation through a communication interface of a secure messaging platform, the communication interface comprising a chat room and a canvas;
select at least a first content item from a content list, the first content item including a song or a music video;
post the first content item to the canvas, wherein the first content item is posted as a first sticker on the canvas;
play the first content item that was posted to the canvas;
select at least a second content item from the content list, wherein the first content item is different from the second content item;
post the second content item to the canvas, the second content item posted after the first content item, wherein the second content item is posted as a second sticker on the canvas; and
queue the second content item to play after the first content item.

12. The system of claim 11, wherein the canvas is included in a separate interface from the chat room.

13. The system of claim 11, wherein the canvas includes a virtual space in which users can collaboratively share, curate, and/or consume the same content items.

14. The system of claim 11, wherein a first user selects and posts the first content item, and a second user selects and posts the second content item.

15. The system of claim 14, wherein the first user is different from the second user.

16. The system of claim 11, wherein the secure messaging platform may be configured to facilitate end-to-end encryption for message-based communications between users.

17. The system of claim 11, wherein the content list is arranged based on one or more of popularity of individual content items in the content list, user preferences, users personal playlists, playlists of contacts of a user, and/or preferences of contacts of a user.

18. The system of claim 11, wherein playback of the first content item and the second content item is configured to be controllable by any user accessing the canvas.

19. The system of claim 11, wherein the one or more hardware processors are further configured by machine-readable instructions to:
generate a playlist based on the selected content items; and
record a motion of a sticker.

20. A non-transient computer-readable storage medium having instructions embodied thereon, the instructions being executable by one or more processors to perform a method for sharing content, the method comprising:
initiating a conversation through a communication interface of a secure messaging platform, the communication interface comprising a chat room and a canvas, wherein the chat room includes a virtual space in which users can exchange message-based communications, and wherein the canvas includes a virtual space in which users can collaboratively share, curate, and/or consume the same content items;
selecting at least a first content item from a content list, the first content item including a song or a music video, wherein the content list is arranged based on one or more of popularity of individual content items in the content list, user preferences, personal playlists of a user, playlists of contacts of a user, and/or preferences of contacts of a user;
posting the first content item to the canvas, wherein the first content item is posted as a first sticker on the canvas;
playing the first content item that was posted to the canvas;
selecting at least a second content item from the content list, wherein the first content item is different from the second content item;
posting the second content item to the canvas, the second content item posted after the first content item, wherein the second content item is posted as a second sticker on the canvas, and wherein the second content item is depicted on the canvas as being positioned at least partially below or behind the first content item; and
queuing the second content item to play after the first content item, wherein playback of the first content item and the second content item is configured to be controllable by any user accessing the canvas.
